(19) United States
(12) Patent Application Publication
(10) Pub. No.: US 2010/0181790 A1
(43) Pub. Date: Jul. 22, 2010

(54) LIFTING TOOL FOR PREFABRICATED DWELLING MODULES

(75) Inventor: José Javier Fernández Fernández, Ortuella (ES)

Correspondence Address: MERCHANT & GOULD PC, P.O. BOX 2903, MINNEAPOLIS, MN, 55402-0903, US

(73) Assignee: HABIDITE, S.A., Ortuella (ES)

(21) Appl. No.: 12/517,161

(22) PCT Filed: Nov. 30, 2007
(86) PCT No.: PCT/ES07/00702

§ 371 Date: Mar. 8, 2010

(30) Foreign Application Priority Data
Dec. 1, 2006 (ES) P200603078

(51) Int. Cl. E04G 21/16; B66C 1/66; E04G 21/14

(52) U.S. Cl. 294/89

(57) ABSTRACT

The invention relates to a lifting tool for prefabricated dwelling modules, specifically for industrialized modules having recesses (2) with frustoconical bases on at least one of the edges thereof, said recesses being provided with a metal coating (3) which co-operates with a base flat (4) having a central threaded hole in which a leveling screw (7) is inserted with play. The tool comprises a main body (8-8′) having the same general configuration and size as the recess (2) in the module (1). The main body is provided with a plurality of bolts (13-14, 13′-14′, 21) which can project from said body, the free outer ends of which terminate in a beveled edge (41-41′, 22) which facilitates the retraction of the bolts upon contact with the walls of the recess (2). The bolts are controlled by cams (16, 26-27) which move the bolts longitudinally in order to lock/unlock the tool in relation to the module (1) to be lifted.

### OBJECT OF THE INVENTION

The present invention relates to a tool which has been especially designed for the temporary fixing to an industrialized module intended to form part of a dwelling, to the corresponding crane or handling element for handling said module. An industrialized module will be understood as that which is formed by a prefabricated structure and the remaining minimum coatings and pre-installations for constructing a dwelling.

The object of the invention is to achieve a tool which allows using the actual structure of the module to be handled for said temporary fixing without needing to implement in said module additional elements specifically intended for its handling.

The invention is thus located in the scope of tools for the construction industry.

### BACKGROUND OF THE INVENTION

There are many modular systems for constructing dwellings, for example based on reinforced concrete panels, provided with coupling means for the coupling, both in a side and in a vertical direction, with other modules which are handled by means of cranes in the assembly. To suitably fix said modules during their handling, there are usually rings or eyebolts associated to the metal framework or structure of the module, which project to the outside thereof in order to be able to couple supporting hooks to them, a solution which, although it is effective from the operative point of view, on many occasions creates problems in the assembling between modules due to the actual presence of said anchorings.

The applicant is the proprietor of Spanish invention patent P 200603078, which describes a modular construction system for dwellings, in which the modules have tongue and groove coupling means consisting of frustoconical protrusions located at their lower edge, which can be tightly inserted in also frustoconical recesses of their upper edge. The mentioned frustoconical recess has a metal coating for the concrete, with the same configuration, welded at the lower part and stiffened by means of side plates to a flat having a central threaded hole, in which a leveling screw is located. The lifting tool proposed by the invention provides the temporary use of this recess for handling the module.

### DESCRIPTION OF THE INVENTION

As has just been stated, the tool of the invention allows using the structure of the module at the level of its recess for the coupling between modules to provide a solid fixing of said module to the crane of handling element used for the purpose.

To that end, said tool is formed from a main body, which in general lines adopts a configuration complementary to that of the mentioned recess, i.e., with a lower end with a frustoconical configuration, in which body there is defined a diametric guide in which the longitudinally movable coupling means can be inserted with play, such that said coupling means can lock the tool to the module, either on the head of the leveling screw of the module, or by means of the existence on the conical wall of the recess of a groove receiving such coupling means.

In any case, the retraction of the coupling means, i.e., their adoption of an operating situation, is determined by the actual introduction of the tool in the recess, and this situation is passed to the locking situation by means of a manually actuated mobile body or cam.

Based on this basic structuring, the coupling means can be formed, in each of the two halves of the diametric guide, as at least two pairs of bolts, preferably four, tending to move closer to one another by means of a spring connecting them, such that the cam acts between these two bolts to cause the locking on the head of the leveling screw, or they can be a single bolt which, with the cooperation of a double cam, moves outwards or inwards depending on the position adopted by a vertically movable core and which incorporates the mentioned cams acting by means of inclined planes, specifically in the case in which the bolts or coupling means are intended to be interlocked in grooves of the frustoconical housing.

In the first case, the cam, which is retractable against the tension of a spring, is manually actuated through a threaded handle, whereas in the second case, the double cam is mobilized by the also manual upward movement of the central core.

It must also be indicated that in this second case, the main body has a neck covering the area of the core in which there is provided the hole for the passage of the supporting shackle, such that said shackle can only be coupled to the device when the latter is in turn locked with respect to the module to be handled, which is very interesting from the point of view of safety since there is no possibility of lifting the module while the device is not perfectly fixed thereto.

### DESCRIPTION OF THE DRAWINGS

To complement the description which is being made and for the purpose of aiding to better understand the features of the invention according to preferred practical embodiment thereof, a set of drawings is attached as an integral part of said description, in which the following has been shown with an illustrative and non-limiting character:

FIG. 1 shows a section perspective view of the lifting tool for prefabricated dwelling modules forming the object of the present invention.

FIG. 2 shows a side elevational and diametric section view of the tool of the previous figure duly opposed to the prefabricated module which it must lift, which has only been partially shown.

FIG. 3 shows, according to a representation similar to FIG. 2, the same assembly of said figure but in a situation of coupling of the tool to the module and before the fixing between both elements.

FIG. 4 again shows a representation similar to that of FIGS. 2 and 3, in which the tool and module are duly locked, the module being in a lifted situation.

FIGS. 5, 6, 7 and 8 show representations respectively similar to those of FIGS. 1, 2, 3 and 4, corresponding to a second embodiment variant of the tool.

### PREFERRED EMBODIMENT OF THE INVENTION

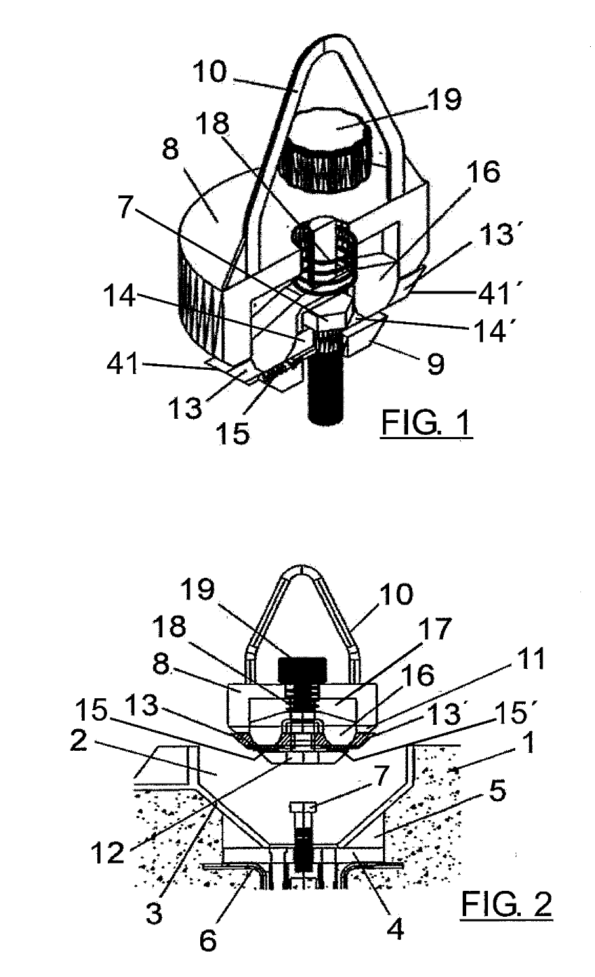

In view of the indicated figures, particularly FIGS. 1 to 4, it can be observed how the proposed tool is intended for handling, specifically for lifting prefabricated modules (1) for dwellings and the like, in which there are defined frustoconical housings (2) intended for the tongue and groove coupling between modules, provided with a metal coating (3) on their frustoconical surface which is fixed by means of welding to a base flat (4) partially embedded in the concrete forming the module (1), and stiffened by means of triangular and upper side plates (5) and corrugated and lower rods (6), the mentioned flat (4) being provided at its center with a threaded hole for coupling a leveling screw (7).

The proposed tool is formed from a main body (8) with a frustoconical front (9) which is suitable in size and shape for the frustoconical surface (3) of the module to which it must be coupled, a catch (10) for coupling the hook of the crane, not shown in the drawings, projecting upwardly and integrally from such body.

Inside this main body (8) there is provided a diametric guide (11) crossed with an axial hole (12), the latter being suitable in size to allows the passage of the leveling screw (7) of the module (1), whereas in each of the two halves of the guide (11) two pairs of locking elements (13-14) and (13′-14′) are respectively inserted with play, which elements are aligned and connected by means of respective springs (15-15′) working under extension and consequently forcing the mentioned coupling elements or mentioned bolts to tend to move closer to one another.

Between each pair of bolts (13-14) and (13′-14′) there is provided the corresponding end of a double cam-bridge (16) which is inserted with play inside a chamber (17) defined in the actual main body (8), said cam (16) being permanently pressed against the bolts (13-14) and (13-14′) due to the effect of an upper spring (18) coaxially assembled on a threaded handle (19) acting as a pushing element for it.

According to this structuring, the operation of the tool is the following:

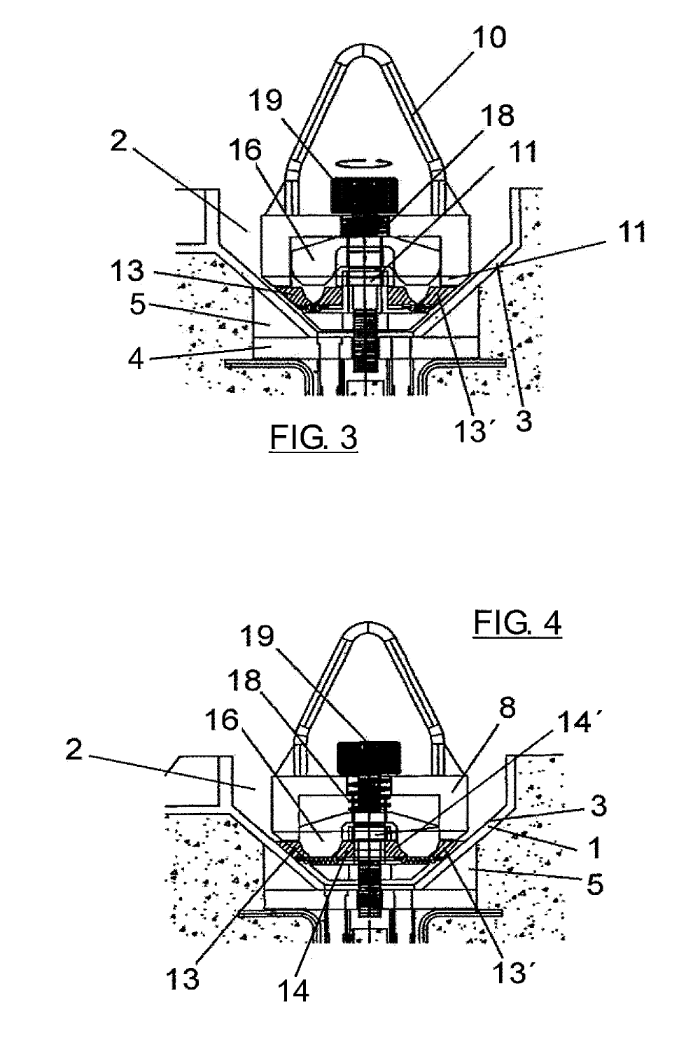

Starting from the rest position shown in FIG. 2, in which the double cam-bridge (16) keeps the bolts (13-14) and (13′-14′) of each pair of bolts separated as much as possible against the springs (15-15′), when the tool penetrates the recess (2) of the module, as shown in FIG. 3 the springs (15-15′) can be released if the threaded handle (19) is directly acted upon, which causes, as a result of the beveled and also inclined edges (41-41′) of the mentioned outer bolts (13-13′), the retraction of the double cam-bridge (16) against the pressure exerted by the spring (18), whereby the bolts (13-14) and (13′-14′) of each pair of bolts move closer to one another, and more specifically, the inner bolts (14-14′) allow the free passage to the head of the leveling screw (7).

In this situation, when the automatic spring (18) returning to its previous position, it causes a downward movement of the cam-bridge (16) tending to penetrate between each pair of bolts (13-14) and (13′-14′), causing the separation thereof until a limit situation in which the inner bolts (14-14′) lock the leveling screw (7) immediately under its head, said screw thus being rigidly attached to the tool, and the prefabricated module as a whole also being attached to said tool to prevent a rotation of the tool assembly from being able to bend the leveling screw (7).

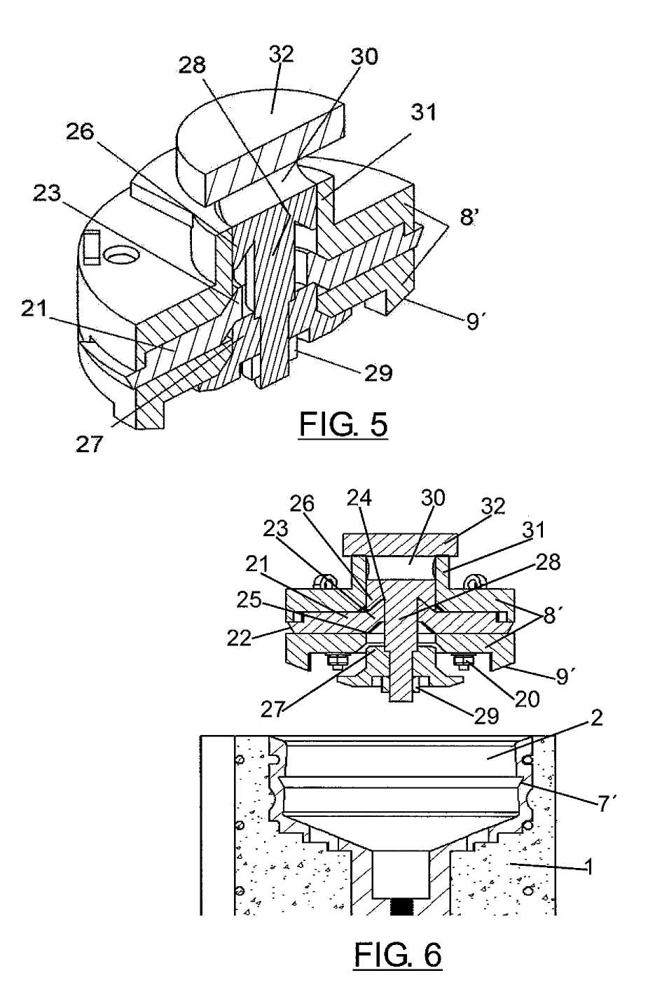

As has been stated above, FIGS. 5 to 8 show an embodiment variant of the lifting tool of the previous figures, in which the same references have been used to identify coincident parts or elements.

In this second case, it has been provided that instead of using the leveling screw (7) of the module (1) as a means for fixing the tool to the module (1), an angular groove (7′) provided in the side wall of the recess (2) is used.

The actual tool is in turn also formed by means of a main body (8′) provided with a frustoconical front (9′), said body being divided into portions integral with one another by means of screws (20) and suitably separated to house between them at least one pair of counterposed bolts (21), preferably four, like in the first practical embodiment, equiangularly distributed, in each of which there is provide an outer beveled edge (22) favoring the retraction thereof towards the inside of the body (8′) when the latter penetrates the housing (2) of the module (1), and with its obliquely upward bent inner end (23) defining two parallel inclined edges or planes (24-25), an upper inclined plane (24) and a lower inclined plane (25), on which a double cam (26-27) acts, the upper cam (26) being integrated in an axial core (28), whereas the lower cam (27) is fixed to said core with the cooperation of a nut (29). The frustoconical front (9) will have a height such that when the tool rests in the housing (2) of the module (1), the bolts (21) will be located such that they are aligned with the angular groove (7′), the outer beveled edges (22) opposing said groove.

In a retraction situation for the bolts (21) and as is especially observed in FIG. 6, the core (28) adopts a lower limit position in which the diametric and upper hole (30) for the passage of the fixing shackle (40) for fixing the hook of the crane is concealed by a cylindrical neck (31), an upward extension of the main body (8′), the head (32) of the central core (28), allowing the manual actuation thereupon with the subsequent actuation on the cams (26 and 27), being in turn outside said neck (31).

According to this structuring, the operation of this practical embodiment variant of the device is the following:

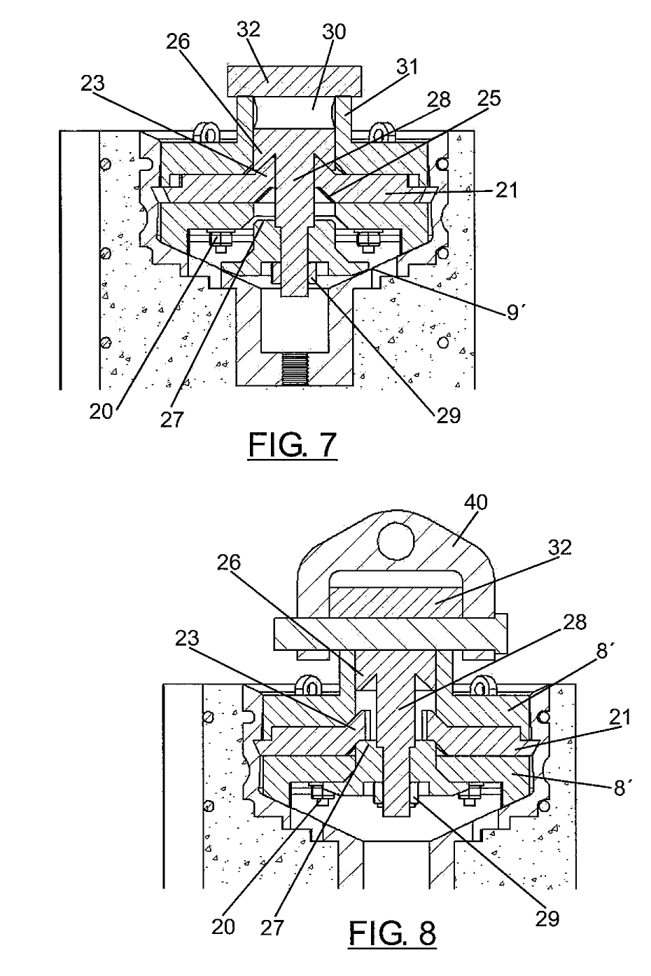

Starting from the rest situation for the tool shown in FIG. 6, when said tool is coupled in the housing (2) of the module, in the position shown in FIG. 7, the free outer ends (22) of the bolts (21) contact the wall of said housing (2) in the event that they are in a prominent situation (which could be manually prevented by acting on the core (28)), such as for example that shown in FIG. 5, whereby the inner limit position of the bent inner end (23) of the bolt (21) allows the downward movement of the cams (26) and, consequently, the downward movement of the core (28) to the limit unlocking situation shown in FIG. 7.

In this situation the hole (30) for the passage of the fixing shackle (40) is concealed, such that it is not possible to assemble said shackle insofar as it is not pulled manually upwards on the mentioned core (28), so that the hole (30) is unopposed to the neck (31) of the main body (8′).

In this upward movement of the core (28), the lower cam (27) contacts the lower inclined plane (25) of the bolts (21), causing the radial propulsion thereof and their fitting in the groove (7′), whereby the tool is locked to the module (1) which is to be handled. In this position the shackle (40) can already be implemented, and the maneuver for handling the module can be carried out with complete safety assurances.

1. A lifting tool for industrialized dwelling modules having recesses with frustoconical bases on at least one of the edges thereof, which recesses are provided with a metal coating which cooperates with a base flat having a central threaded hole in which a leveling screw is inserted with play, said lifting tool comprising a main body, with the same general configuration and size as the recess of the module, in which there is provided a plurality of bolts which can project from the main body and terminate at their free outer end in a beveled edge which facilitates the retraction thereof upon contact with the walls of the recess, these bolts being controlled by cams which move such bolts longitudinally in order to lock/unlock the actual tool in relation to the module to be lifted, wherein each bolt comprises two bolts, the bolts of each pair being longitudinally aligned and connected to one another by means of respective springs and working under traction and tending to move said bolts closer to one another, between which there is located a double cam-bridge tending to separate them, the inner bolts being located in a limit position in which they are adapted to both sides of the leveling screw immediately under its head.

2. The lifting tool for prefabricated dwelling modules according to claim 1, the mentioned bolts are inserted with play in diametric guides of the main body which open up towards an upper chamber in which the mid-area of the double cam-bridge is housed.

3. The lifting tool for prefabricated dwelling modules according to claim 1, wherein the double cam-bridge is aided in its mid-area by a spring moving it downwards, overcoming the tension of the springs connecting the bolts and, a manually actuated threaded handle being provided in the upper and mid-area of the main body, which handle causes the separation of the bolts and inside the recess and the definitive irremovable fixing of the leveling screw immediately under its head.

4. The lifting tool for prefabricated dwelling modules according to claim 1, wherein the main body is integral at the upper part with a catch for coupling the hook of the crane for handling the modules.

5. A lifting tool for industrialized dwelling modules having recesses with frustoconical bases on at least one of the edges thereof, which recesses are provided with a metal coating which cooperates with a base flat having a central threaded hole in which a leveling screw is inserted with play, which lifting tool comprises a main body, with the same general configuration and size as the recess of the module, in which there is provided a plurality of bolts which can project from the main body and terminate at their free outer end in a beveled edge which facilitates the retraction thereof upon contact with the walls of the recess, these bolts being controlled by cams which move such bolts longitudinally in order to lock/unlock the actual tool in relation to the module to be lifted, wherein the bolts terminate at their outer end in a beveled edge forming a means for locking said bolts in a groove in the wall of said recess and at their inner end they terminate in an oblique bend determining two parallel inclined edges or planes on which a double cam formed by an upper cam and a lower cam acts.

6. The lifting tool for prefabricated dwelling modules according to claim 5, wherein the upper cam is associated to an axially movable core, on the lower end of which the lower cam is assembled, which cam is fixed by means of a nut, all this such that the downward movement of the upper cam causes the retraction of the bolts, whereas the upward movement of the lower cam associated to said upper cam causes the propulsion to the outside according to the radial movement of the bolts.

7. The lifting tool for prefabricated dwelling modules according to claim 5, wherein the mentioned core to which the cams are associated incorporates a diametric hole at an upper level for the passage of the fixing shackle for the fixing to the crane, with the particularity that the main body incorporates an upward neck as an envelopment of the mentioned central body, which neck covers the mentioned diametric hole in a rest situation of the device, such that the mentioned shackle can only be coupled to the tool in a locking situation for its bolts.
